(19) United States
(12) Patent Application Publication
(10) Pub. No.: US 2013/0238419 A1
(43) Pub. Date: Sep. 12, 2013

(54) System Apparatus Circuit Method and Associated Computer Executable Code for Assessing the Relevance and Impact of Secondary Content

(71) Applicant: JINNI MEDIA LTD., Rosh Ha'ayin (IL)

(72) Inventors: Yosef Glick, Yehud (IL); Mordechai Mori Rimon, Jerusalem (IL); Ram Meshulam, Yavne (IL)

(73) Assignee: JINNI MEDIA LTD., Rosh Ha'ayin (IL)

(21) Appl. No.: 13/872,115

(22) Filed: Apr. 28, 2013

Related U.S. Application Data
(63) Continuation-in-part of application No. 12/859,248, filed on Aug. 18, 2010.

(51) Int. Cl. G06Q 30/02

(52) U.S. Cl. CPC G06Q 30/0242
USPC 705/14.41

(57) ABSTRACT

Disclosed are systems, apparatuses, circuits, methods and computer executable code sets for assessing the relevance and impact of a secondary content, such as an advertisement, presented within primary content. A first assessment module is used for assessing a taste profile based relevance and/or impact of the primary content, and/or the secondary content, on the target viewer. A second assessment module is used for assessing a correlation level between the primary content and/or segments thereof, and the secondary content and/or segments thereof.

### RELATED APPLICATIONS

This application is a continuation-in-part of U.S. patent application Ser. No. 12/859,248, filed with the USPTO on Aug. 18, 2010, which is hereby incorporated by reference in its entirety.

### FIELD OF THE INVENTION

The present invention generally relates to the fields of content matching, and targeted and contextual advertising. More specifically, the present invention relates to a system apparatus circuit method and associated computer executable code for assessing the relevance and impact of secondary content (e.g. an advertisement) presented within, and/or in conjunction with, primary content.

### BACKGROUND

In the field of content matching, contextual advertising is a form of targeted advertising or advertisements appearing on websites or other media, such as content displayed in mobile browsers. The advertisements themselves are selected and served by automated systems based on the content displayed to the user.

Basic contextual advertising systems scan the text of a website for keywords and returns advertisements to the webpage based on those keywords. The advertisements may be displayed on the webpage or as pop-up ads. For example, if the user is viewing a website pertaining to sports and that website uses contextual advertising, the user may see advertisements for sports-related companies, such as memorabilia dealers or ticket sellers. Contextual advertising is also used by search engines to display advertisements on their search results pages based on the keywords in the user's query.

In contextual advertising the content of an ad is in direct correlation to the content of the web page the user is viewing. For example, when visiting a website concerning travelling in Europe and an ad pops up offering a special price on a flight to Italy. Contextual advertising is also called “In-Text” advertising or “In-Context” technology.

Taking the above into account, there clearly remains a need, in the fields of content matching, and targeted and contextual advertising, for systems apparatuses circuits methods and associated computer executable code sets that introduce unique approaches to secondary content (e.g. advertisements) relevance and impact assessment, such as an ability to assess relevance and impact of secondary contents, such as ads, based on similarity levels between structured sets of category tags of secondary contents (e.g. advertisements) and structured sets of category tags of primary content items or segments thereof, while considering the taste profile based impact of both, the secondary contents (e.g. advertisements) and the primary content items, on the target viewer.

### SUMMARY OF THE INVENTION

Below are described a number of novel, innovative systems apparatuses circuits methods and associated computer executable code sets for assessing the relevance and impact of secondary content (e.g. advertisement(s)) presented within, and/or in conjunction with, primary content. According to some embodiments of the present invention, there may be provided a computerized assessment system to generate an indicator of relevance and/or impact of secondary content presented, and/or to be presented, in conjunction with some primary content, wherein the system includes: (1) a first assessment module for assessing a taste profile based (e.g. psychological) impact of the primary content, and/or the secondary content (e.g. advertisement(s)), on the target viewer; and, applying one or more distance functions to assess the similarity level between: (a) ‘one or more structured sets of category tags (hereinafter: ‘genes’), selected from a pre-defined taxonomy' (hereinafter: ‘genome’ or ‘genome data set’) of secondary content (e.g. advertisement(s)) and (b) ‘genome data set(s)’ of the primary content or segments thereof; and (2) a second assessment module for assessing a correlation level between the primary content and/or segments thereof, and the secondary content (e.g. advertisement(s)); based on the taste profile based impacts and similarity levels assessed by the first assessment module.

According to some embodiments of the present invention, a system for assessing the relevance of secondary content may comprise: (1) a taste profile based assessment module (i.e. first assessment module) for receiving: (a) Genome data of one or more potential secondary content(s) (e.g. advertisement(s)), (b) overall, and/or two or more per-segment, genome data set(s) of the primary content, and (c) one or more taste profile based preferences/characteristics of the target viewer; and calculating a set of one or more genome delta values between: (i) at least some of the potential secondary content(s) (e.g. advertisement(s)), and (ii) the overall genome data set, and/or at least some of the per-segment genome data set(s), of the primary content; wherein calculated genome delta(s) values may be at least partially affected by the taste profile based preferences/characteristics of the target viewer; and (2) secondary content selection and positioning assessment module (i.e. second assessment module) for assessing, based on the calculated genome deltas, a correlation level between the primary content, or the segments of the primary content, and one or more of the potential secondary content(s) (e.g. advertisement(s)); and selecting one or more secondary content(s) (e.g. advertisement(s)) for presentation in conjunction with the primary content, or segment(s) thereof, at least partially based on the assessed correlation levels.

According to some embodiments of the present invention, a system for assessing the impact of previously presented secondary content may comprise: (1) a taste profile based assessment module (i.e. first assessment module) for receiving: (a) Genome data of the previously presented secondary content, (b) overall genome data set(s) of the primary content, and/or genome data set(s) of the primary content segment where the secondary content was presented, and (c) one or more taste profile based preferences/characteristics of the target viewer; and calculating a set of one or more genome delta values between: (i) the presented secondary content, and (ii) the overall genome data set, and/or at least some of the per-segment genome data set(s), of the primary content; wherein calculated genome delta value(s) may be at least partially affected by the taste profile based preferences/characteristics of the target viewer; and (2) a secondary content impact assessment module (i.e. second assessment module) for assessing, based on the calculated genome delta value(s), a correlation level between the primary content, or the segment of the primary content in which the presented secondary content was positioned, and the presented secondary content; and relaying the assessed correlation level.

According to some embodiments of the present invention, the taste profile based assessment module may compare secondary content genes (e.g. plot, mood) to respective primary content (overall and/or per-segment) genes, calculating one or more sets of delta values between respective genes; for example, such that a larger delta value generally indicates a greater difference in the characteristic represented by that specific gene. According to some embodiments, the taste profile and/or preferences of the viewer/target may be considered as part of assessing the relevance or impact of an secondary content(s). Preferences of the viewer/target may at least partially correspond to, or may be correlated to, secondary content and/or primary content representing genes, and may accordingly be utilized for increasing or decreasing the assessed impact or relevance of a given secondary content. For example, the impact or relevance of a given secondary content within a given primary content, or primary content segment, may be assessed as low, although the genome delta values between the two are considerably small (i.e. small delta values indicate ‘more similar’ genes and thus a better ‘match’), as a result of a projected viewer's/target's preferences not matching the secondary content's genome delta value set.

According to some embodiments of the present invention, the secondary content impact/selection assessment module may utilize the genome delta values, calculated and communicated by the taste profile based assessment module, for assessing the correlation level between the secondary content and the primary content or segment(s) thereof. According to some embodiments, secondary content previously presented in conjunction with a given primary content or given primary content segment, and for which a high correlation level was calculated, may, for example, indicate a high impact for that specific secondary content within that specific primary content or segment thereof.

According to some embodiments of the present invention, one or more secondary contents from which a subset is to be selected and presented in conjunction with a given primary content or given primary content segment, may be compared and correlated to the primary content and/or segments thereof. Secondary content to primary content pair(s) and/or secondary content to primary content segments pair(s), for which higher correlation levels were calculated, may be selected for presentation. According to some embodiments, when comparing multiple secondary contents to a given primary content, the one or more secondary contents for which the highest correlation levels were calculated may be relayed for presentation. According to some embodiments, when comparing multiple secondary contents to multiple segments of a given primary content, the one or more secondary content(s) to segment combinations for which the highest correlation levels were calculated may indicate the secondary content(s) to be presented and the optimal primary content segment for their presentation. The selected secondary contents and possibly their optimal positioning segments may be then relayed for presentation.

According to some embodiments of the present invention, certain genes within the secondary content genome may have a higher, or lower, influence on the calculated impact of a given secondary content or on its selection for presentation. Accordingly, even a secondary content to primary content pair having relatively small delta values for other genes may be considered to have low impact, or low relevance, as an increased, and thus more influential, gene delta value caused its aggregated genome delta values (e.g. in the form of a distance function result) to increase beyond that of other secondary content to primary content pairs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

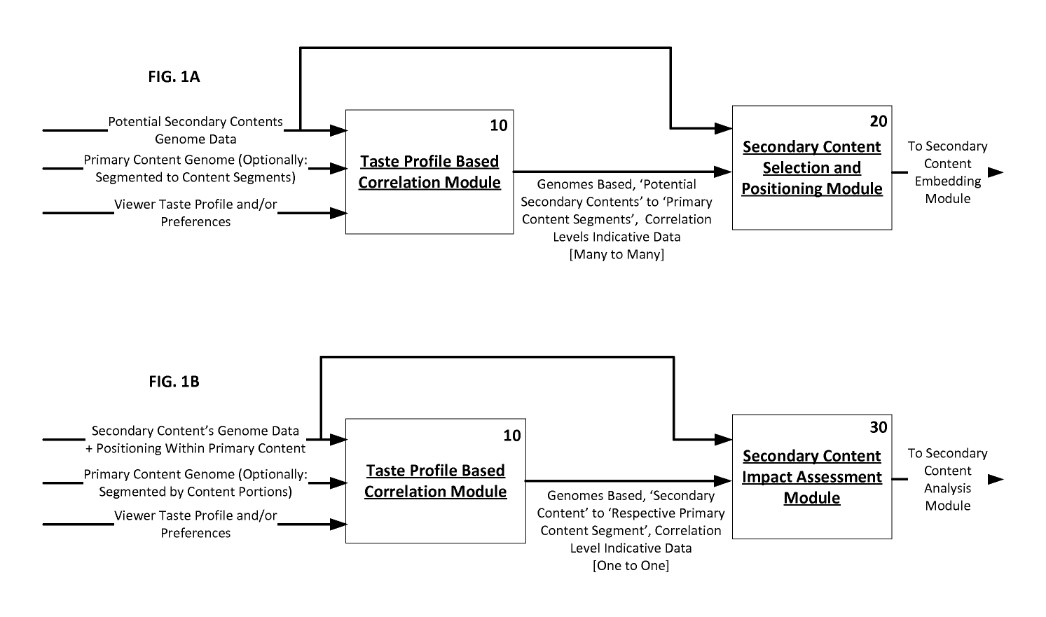

In FIG. 1A there is shown, in accordance with some embodiments of the present invention, a block diagram of an exemplary system for assessing the relevance of secondary contents to a target/viewer;

In FIG. 1B there is shown, in accordance with some embodiments of the present invention, a block diagram of an exemplary system for assessing the impact of previously presented secondary contents on a target/viewer;

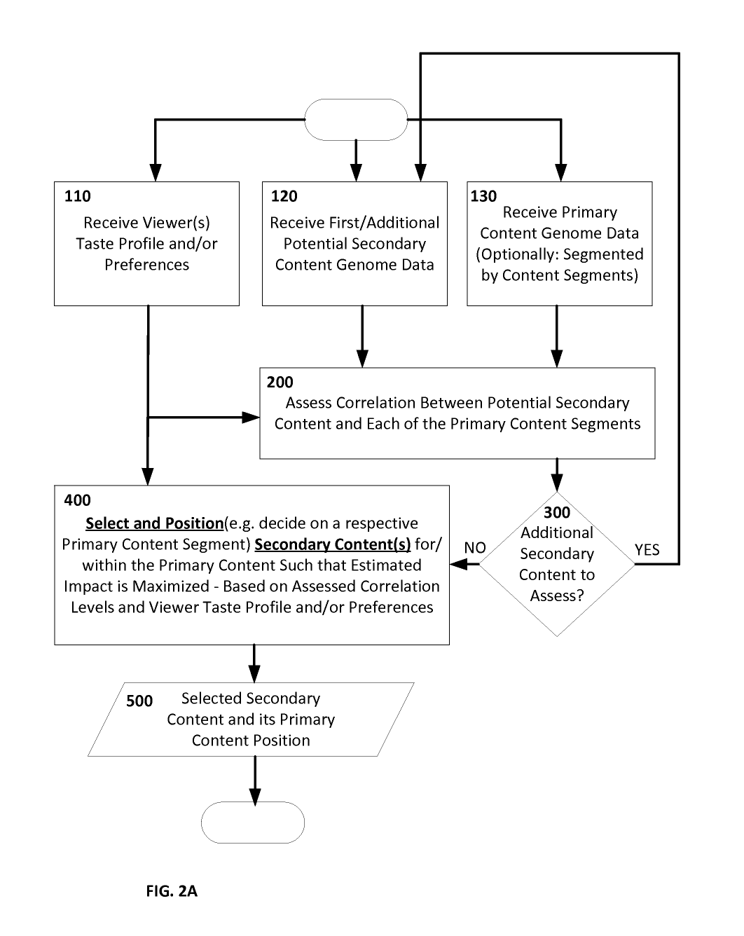

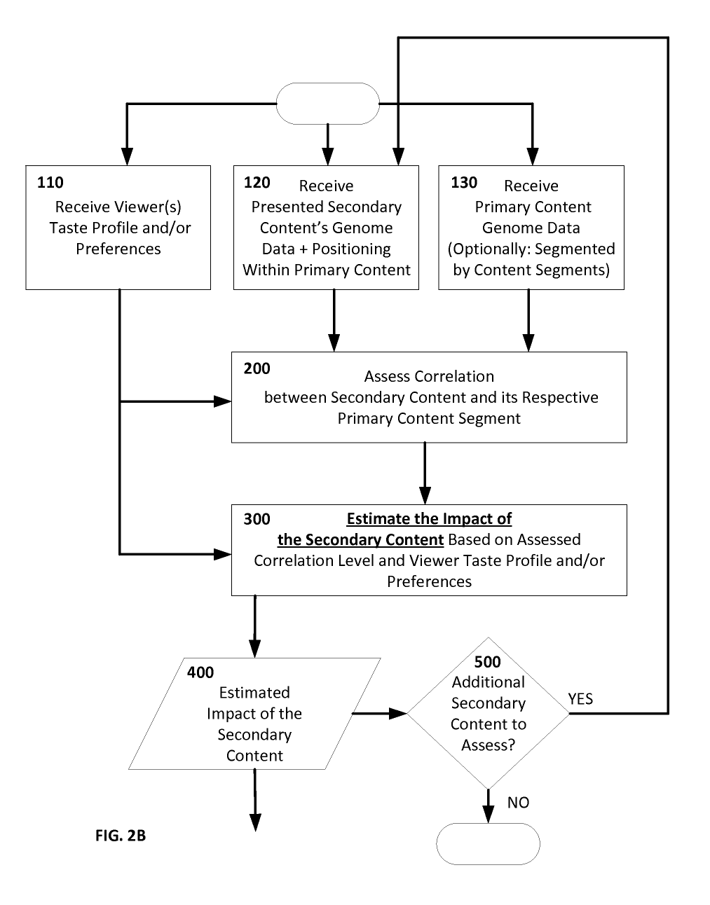

In FIG. 2A there is shown, in accordance with some embodiments of the present invention, a flowchart of the main steps executed by an exemplary system for assessing the relevance of secondary contents to a target/viewer;

In FIG. 2B there is shown, in accordance with some embodiments of the present invention, a flow chart of the main steps executed by an exemplary system for assessing the impact of a secondary content previously presented to a target/viewer.

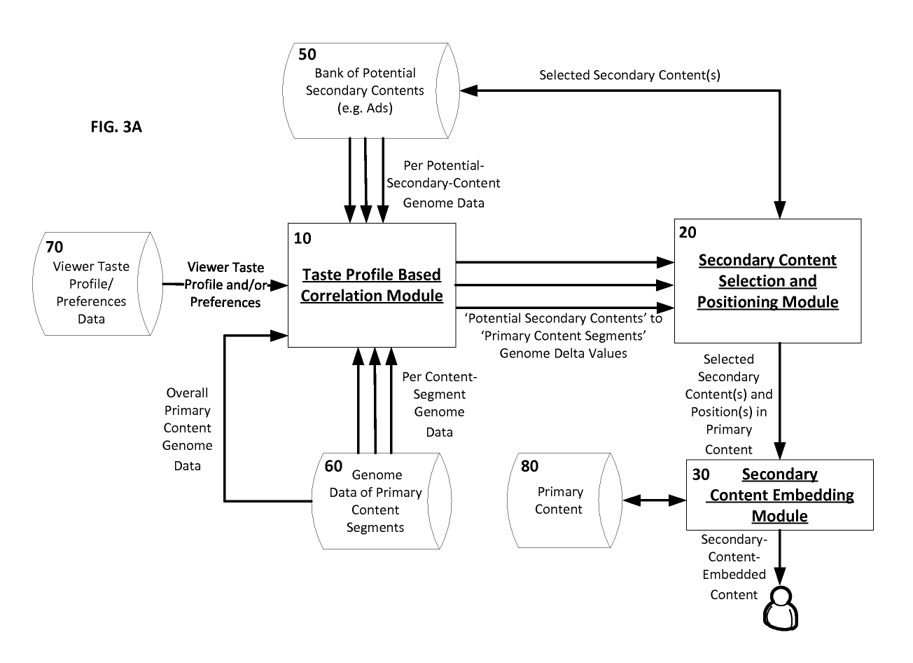

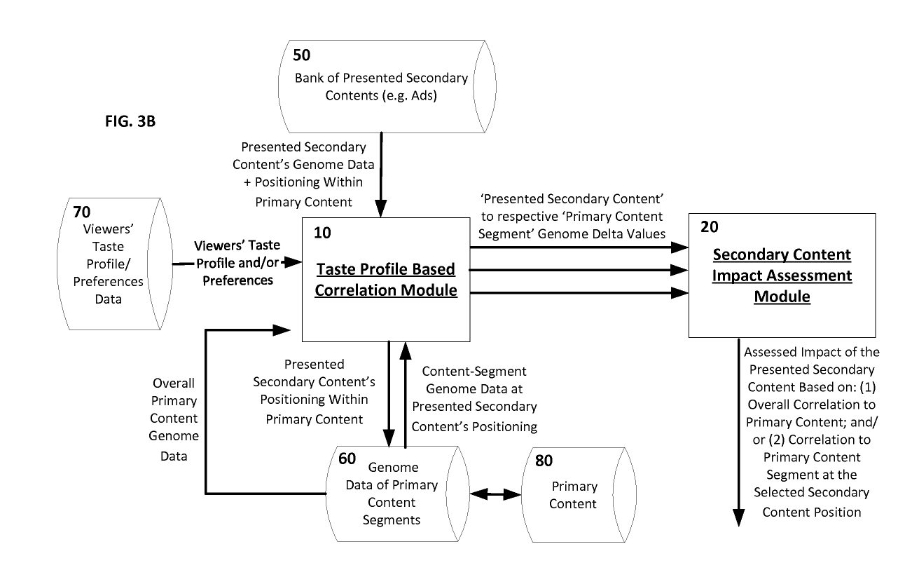

In FIG. 3A there is shown in further detail, in accordance with some embodiments of the present invention, a block diagram of an exemplary system for assessing the relevance of secondary contents to a target/viewer;

In FIG. 3B there is shown in further detail, in accordance with some embodiments of the present invention, a block diagram of an exemplary system for assessing the impact of previously presented secondary content(s) to a target/viewer; and

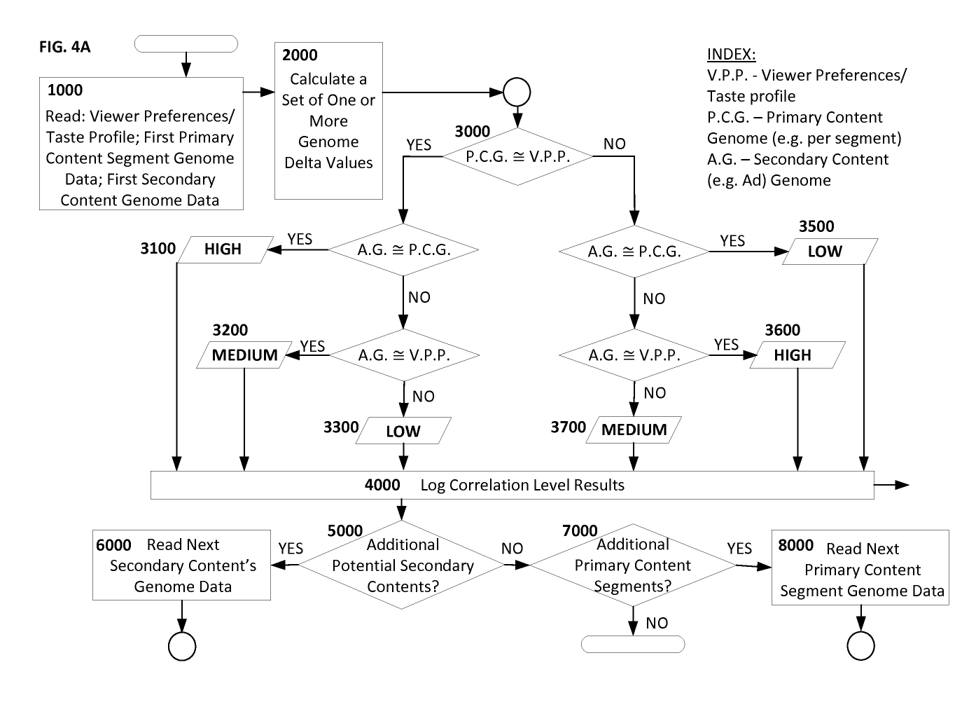

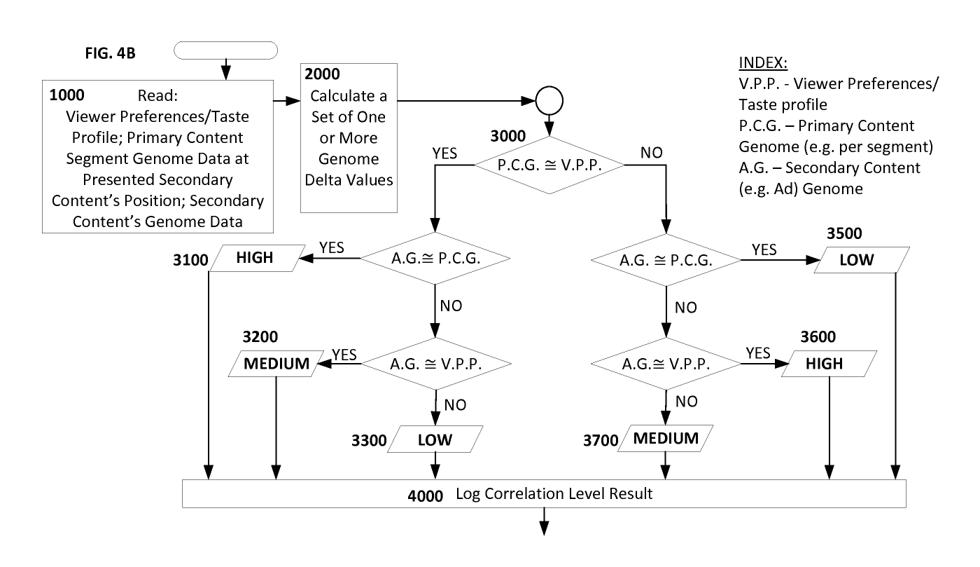

In FIGS. 4A-4B there are shown, in accordance with some embodiments of the present invention, flowcharts of the main steps and decisions executed by a simplified exemplary system for assessing the relevance/impact of secondary contents to a target/viewer, as part of an exemplary secondary content(s) assessment process.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, circuits, apparatuses, systems and associated computer executable code for assessing relevance and/or impact on a target/viewer of a secondary content (e.g. an advertisement) presented to the target/viewer in conjunction with primary content. According to some embodiments, there may be provided a computerized assessment system to generate an indicator of relevance and/or impact of a secondary content presented, and/or to be presented, in conjunction with some primary content, wherein the system includes: (1) a first assessment module for assessing a taste profile based impact (e.g. matches tastes/mood of the target viewer) of the primary content, and/or the secondary content, on the target viewer; and, applying one or more distance functions to assess the similarity level between: (a) ‘one or more structured sets of category tags (hereinafter: ‘genes’), selected from a pre-defined taxonomy' (hereinafter: ‘genome’ or ‘genome data set’) of secondary content (s) and (b) genome data set(s) of the primary content or segments thereof; and (2) a second assessment module for assessing a correlation level between the primary content and/or segments thereof, and the secondary content; based on the taste profile based impacts and similarity levels (e.g. genome similarity levels) assessed by the first assessment module.

According to some embodiments of the present invention, the assessment system may apply any distance function(s), known today or to be devised in the future, in order to assess the level of similarity between two or more genome data sets (a process hereinafter generally referred to as: ‘calculating genome delta values’). According to some embodiments, distance functions applied by the system may include, or be based on, but are in no way limited to: considerations of different weights for different types of categories (e.g. mood vs. plot), salience of each gene in given content item(s); frequency of each gene in an entire content catalogue; and/or relations between genes. Additional exemplary distance functions utilizable by the system are described in U.S. patent application Ser. No. 12/859,248, of which the present application is a continuation-in-part (CIP) application.

According to some embodiments of the present invention, the first assessment module may apply distance functions to calculate distances between clusters, each containing two or more potential target viewers having the least distance (i.e. highest similarity—a substantially similar ‘taste’) between their members. Using the clustered groups, the first assessment module may assess the taste profile based impact(s) of the primary content and/or the secondary content, on one or more clusters/groups, of potential target viewers, sharing substantially similar tastes (e.g. secondary-content/primary-content similarity level to tastes/mood of the target viewers' cluster/group). According to some embodiments, target viewers cluster/group impact assessment may be applied either independently and/or in combination with individual target viewer impact assessment.

According to some embodiments of the present invention for assessing the relevance of a secondary content, pre-presentation assessment may be executed for purposes of dynamic secondary content selection and/or positioning, to maximize impact of the secondary content within primary content selected and/or being viewed by the target. According to some embodiments of the present invention for assessing the impact of a secondary content, post-presentation assessment may be executed for purposes of valuation and/or pricing. Some of the following sections of the invention's description specifically relate to either ‘secondary content relevance assessment’ or ‘secondary content impact assessment’; it is, however, made clear that any feature described in connection with ‘relevance assessment’ embodiments, may likewise be utilized as part of ‘impact assessment’ embodiments and vice versa. Moreover, methods, circuits, apparatuses, systems and associated computer executable code sets, described herein, may be designed in connection with ‘assessing relevance’, ‘assessing impact’ and/or both.

According to some embodiments of the present invention, methods, circuits, apparatuses, systems and associated computer executable code sets, described herein, may be likewise utilized for: assessing the relevance and/or impact on a target/viewer of a second primary content presented/to-be-presented to the target/viewer in conjunction with, or following to, the first primary content; and/or assessing the relevance and/or impact on a target/viewer of any second content presented/to-be-presented to the target/viewer in conjunction with, or following to, a first primary content; and/or for providing indicator(s) of relevance and/or impact, and/or content recommendation(s).

According to some embodiments of the present invention, a system for assessing the relevance of an secondary content may comprise: (1) a taste profile based assessment module for receiving: (a) Genome data of one or more potential secondary contents, (b) overall, and/or two or more per-segment, genome data set(s) of the primary content, and (c) one or more taste profile preferences/characteristics of the target viewer; and calculating a set of one or more genome delta values between: (i) at least some of the potential secondary content(s), and (ii) the overall genome data set, and/or at least some of the per-segment genome data set(s), of the primary content; wherein calculated genome delta(s) values may be at least partially affected by the taste profile based preferences/characteristics of the target viewer; and (2) an secondary content selection and positioning assessment module for assessing, based on the calculated genome deltas, a correlation level between the primary content, or the segments of the primary content, and one or more of the potential secondary contents; and selecting one or more secondary content(s) for presentation in conjunction with the primary content, or segment(s) thereof, at least partially based on the assessed correlation levels.

According to some embodiments of the present invention, a system for assessing the impact of a previously presented secondary content may comprise: (1) a taste profile based assessment module for receiving: (a) Genome data of the previously presented secondary content, (b) overall genome data set(s) of the primary content, and/or genome data set(s) of the primary content segment where the secondary content was presented, and (c) one or more taste profile preferences/characteristics of the target viewer; and calculating a set of one or more genome delta values between: (i) the presented secondary content, and (ii) the overall genome data set, and/or at least some of the per-segment genome data set(s), of the primary content; wherein calculated genome delta value(s) may be at least partially affected by the taste profile based preferences/characteristics of the target viewer; and (2) a secondary content impact assessment module for assessing, based on the calculated genome delta value(s), a correlation level between the primary content, or the segment of the primary content in which the presented secondary content was positioned, and the presented secondary content; and relaying the assessed correlation level.

According to some embodiments of the present invention, the taste profile based assessment module may compare secondary content genes (e.g. plot, mood) to respective primary content (overall and/or per-segment) genes, calculating one or more sets of delta values between respective genes; for example, such that a larger delta value generally indicates a greater difference in the characteristic represented by that specific gene. According to some embodiments, the taste profile and/or preferences of the viewer/target may be considered as part of assessing the relevance or impact of a secondary content(s). Preferences of the viewer/target may at least partially correspond to, or be correlated to, secondary content and/or primary content representing genes, and may accordingly be utilized for increasing or decreasing the impact or relevance of a given secondary content. For example, the impact or relevance of a given secondary content within a given primary content, or primary content segment, may be assessed as low, although the genome delta values between the two are considerably small (i.e. small delta values indicate ‘more similar’ genes and thus a better ‘match’), as a result of a projected viewer's/target's preferences not matching the secondary content's genome delta value set.

According to some embodiments of the present invention, the secondary content impact/selection assessment module may utilize the genome delta values, calculated and communicated by the taste profile based assessment module, for assessing the correlation level between the secondary content and the primary content or segment(s) thereof. According to some embodiments, a secondary content previously presented in conjunction with a given primary content or given primary content segment, and for which a high correlation level was calculated, may, for example, indicate a high impact for that specific secondary content within that specific primary content or segment thereof.

According to some embodiments of the present invention, one or more secondary contents from which a subset is to be selected and presented in conjunction with a given primary content or given primary content segment, may be compared and correlated to the primary content and/or segments thereof. Secondary content to primary content pair(s) and/or secondary content to primary content segments pair(s), for which higher correlation levels were calculated, may be selected for presentation. According to some embodiments, when comparing multiple secondary contents to a given primary content, the one or more secondary contents for which the highest correlation levels were calculated may be relayed for presentation. According to some embodiments, when comparing multiple secondary contents to multiple segments of a given primary content, the one or more secondary content(s) to segment combinations for which the highest correlation levels were calculated may indicate the secondary content(s) to be presented and the optimal primary content segment for their presentation. The selected secondary contents and possibly their optimal positioning segments may be then relayed for presentation.

According to some embodiments of the present invention, the correlation level of a given secondary content to a given primary content or segment thereof may, for example, be calculated by: (i) Applying one or more of the above described distance functions (e g summing up the genome delta values) for each ‘secondary content to primary content’, or ‘secondary content to primary content segment’ pair; and (ii) finding and selecting the one or more pairs (e.g. corresponding to the number of secondary contents wanted) having the least distance (i.e. highest similarity) between their members (e.g. a minimal genome delta values sum(s) between pair members).

According to some embodiments of the present invention, certain genes within the secondary-content/primary-content genome may have a higher, or lower, influence on the calculated impact of a given secondary content or on its selection for presentation. For example, a ‘mood’ gene match between an advertisement and a primary content may be considered more important to the advertiser; thus, the calculated delta value of that gene may be increased (e.g. doubled) prior to impact or relevance calculation. Accordingly, even a secondary content to primary content pair having relatively small delta values for other genes may be considered to have low impact, or low relevance, as its increased (e.g. doubled), and thus more influential, ‘mood’ gene delta value caused its aggregated genome delta values (e.g. in the form of a distance function result) to increase beyond that of other secondary content to primary content pairs. According to some embodiments, when calculating secondary content impact or relevance, certain genes may be not considered. For example, an advertiser assuming that regardless of the possible lack of ‘theme’ correlation between a given advertisement and a given primary content, as long as the ‘mood’ correlates the advertisement will have a strong impact and/or relevance; may request for the ‘theme’ gene delta values to not be aggregated along with the rest of the genes (e.g. not to be an argument in the distance function) thus eliminating its effect.

### DESCRIPTION OF THE DRAWINGS

In FIG. 1A there is shown, in accordance with some embodiments of the present invention, a block diagram of an exemplary system for assessing the relevance of secondary contents to a target/viewer. A Taste Profile Based Correlation Module (10) receives/reads: genome data of potential secondary contents for presentation, genome data of primary content in which selected secondary content(s) are to be embedded and/or genome data of segments thereof, and viewer taste profile and/or preferences. The Taste Profile Based Correlation Module (10) derives/calculates, based on their genome data, data indicative of the correlation level between some or all of the potential secondary content(s) and the primary content, and/or data indicative of the correlation level between some or all of the potential secondary content(s) and some or all of the segments of the primary content.

According to some embodiments, the Taste Profile Based Correlation Module (10) further derives/calculates, based on their genome data and taste profile based preferences, data indicative of the correlation level between some or all of the potential secondary content(s) and the projected viewer(s), and/or data indicative of the correlation level between some or all of the segments of the primary content and the projected viewer(s). According to some embodiments, the Taste Profile Based Correlation Module (10) uses the taste profile based preferences of the projected viewer(s) for adjusting previously derived/calculated secondary content(s) to ‘primary-content/primary-content-segments’ correlation levels.

Derived/calculated correlation indicative data is relayed to a Secondary content Selection and Positioning Module (20) that uses it to calculate a genomes based correlation level value between each potential secondary content and the overall primary content, or between each potential secondary content and each of the primary content segments. The Selection and Positioning Module (20) then selects one or more secondary contents that received the highest correlation level value(s) to the primary content, or one or more ‘secondary content’ to ‘primary content segment’ couples that received the highest correlation level value(s) to each other. According to some embodiments, the Selection and Positioning Module (20) only selects secondary contents/couples having a correlation value greater than a predetermined threshold. Accordingly, under certain scenarios no secondary contents may be selected, for example, if no secondary content/couple has received a greater than threshold correlation level value. Selected secondary contents and/or their selected positions are relayed to an integrated, or a third party, Secondary Content Embedding Module/System.

In FIG. 1B there is shown, in accordance with some embodiments of the present invention, a block diagram of an exemplary system for assessing the impact of previously presented secondary contents on a target/viewer. The Taste Profile Based Correlation Module (10) receives/reads: genome data of the presented secondary content and its positioning within the primary content, genome data of primary content in which the secondary content was presented and/or genome data of segments thereof, and viewer taste profile and/or preferences. The Taste Profile Based Correlation Module (10) derives/calculates, based on their genome data, data indicative of the correlation level between the presented secondary content and the primary content, and/or data indicative of the correlation level between the presented secondary content and some or all of the segments of the primary content.

According to some embodiments, the Taste Profile Based Correlation Module (10) further derives/calculates, based on their genome data and taste profile preferences, data indicative of the correlation level between the presented secondary content and its actual or estimated viewer(s), and/or data indicative of the correlation level between the segment of the primary content in which the secondary content was presented and its actual or estimated viewer(s). According to some embodiments, the Taste Profile Based Correlation Module (10) uses the taste profile based preferences of the actual or estimated viewer(s) for adjusting previously derived/calculated ‘presented secondary content’ to ‘primary-content/primary-content-segment’ correlation levels.

Derived/calculated correlation indicative data is relayed to a Secondary Content Impact Assessment Module (30) that uses it to calculate an ‘secondary content impact indicative’ genomes based correlation level value between the presented secondary content and the overall primary content, or between the presented secondary content and the primary content segment in which it was presented. Calculated secondary content impact indicative values are relayed to an integrated, or a third party, Secondary Content Analysis Module/System (e.g. an Advertising Valuation/Pricing Module/System).

In FIG. 2A there is shown, in accordance with some embodiments of the present invention, a flowchart of the main steps executed by an exemplary system for assessing the relevance of secondary contents to a target/viewer. The method exemplified comprises the following steps: Receiving viewer(s) taste profile and/or preferences (110), genome data of a first potential secondary content for presentation (120), and primary content genome data, optionally segmented to content portions (130); Based on the received data, assessing the correlation level between the first potential secondary content and each of the primary content segments (200), and checking whether additional secondary contents, designated as potential for the current primary content, are awaiting assessment (300).

If additional secondary contents are awaiting assessment, the system advances to receiving genome data of an additional (i.e. next) potential secondary content for presentation (120) and assessing the correlation level between the additional potential secondary content and each of the primary content segments (200). The process is repeated until no additional potential secondary contents are awaiting assessment and the system proceeds to selecting for presentation (i.e. choosing one or more secondary contents) and positioning within the primary content (i.e. deciding on a respective primary content segment) one or more secondary contents having maximal estimated impact—based on the assessed correlation levels of the examined secondary contents to the different primary content segments, and the taste profile and/or preferences of the projected viewers (400). Finally, data indicative of the selected secondary content(s) and their positioning within the primary content is relayed to functionally associated, or networked, secondary content analysis and/or embedding modules/systems (500).

In FIG. 2B there is shown, in accordance with some embodiments of the present invention, a flow chart of the main steps executed by an exemplary system for assessing the impact of a secondary content previously presented to a target/viewer. The method exemplified comprises the following steps: Receiving viewer(s) taste profile and/or preferences (110), genome data of a previously presented secondary content and the segment within the primary content in which it was positioned (120), and primary content genome data, optionally segmented to content portions (130); Based on the received data, assessing the correlation level between the presented secondary content and its respective primary content segment (200), and estimating (e.g. by ranking) the impact of the secondary content based on the assessed correlation level and the taste profile of the viewer(s) who were presented with the primary content in which the secondary content was embedded (300).

Data indicative of the impact of the secondary content, at the positioning within the primary content in which it was presented, is relayed to functionally associated, and/or networked, secondary content (e.g. advertisements) analysis, valuation and/or pricing modules/systems (400). The system then proceeds to checking whether additional secondary contents, previously presented within the current primary content, are awaiting impact assessment (500). If additional secondary contents are awaiting assessment, the system repeats the process for the additional (i.e. next) secondary content(s) presented.

In FIG. 3A there is shown in further detail, in accordance with some embodiments of the present invention, a block diagram of an exemplary system for assessing the relevance of secondary contents to a target/viewer. The Taste Profile Based Correlation Module (10) receives/reads: genome data of potential secondary contents for presentation from a Bank of Potential Secondary Contents (50), overall and per-segment genome data of the primary content in which selected secondary content(s) are to be embedded from a Primary Content Genome Data Storage (60), and viewer taste profile and/or preferences data from a Viewer Taste Profile and/or Preferences Data Storage (70). The Taste Profile Based Correlation Module (10) derives/calculates, based on their genome data, data indicative of the correlation level between some or all of the potential secondary content(s) and the primary content, and/or data indicative of the correlation level between some or all of the potential secondary content(s) and some or all of the segments of the primary content.

According to some embodiments, the Taste Profile Based Correlation Module (10) further derives/calculates, based on their genome data and taste profile based preferences, data indicative of the correlation level between some or all of the potential secondary content(s) and the projected viewer(s), and/or data indicative of the correlation level between some or all of the segments of the primary content and the projected viewer(s). According to some embodiments, the Taste Profile Based Correlation Module (10) uses the taste profile based preferences of the projected viewer(s) for adjusting previously derived/calculated secondary content(s) to ‘primary-content/primary-content-segments’ correlation levels.

Derived/calculated correlation indicative data, represented as ‘Potential Secondary Contents’ to ‘Primary Content and/or Primary Content Segments’ genomes delta values, are relayed to a Secondary Content Selection and Positioning Module (20) that uses them to calculate a genomes based correlation level value between each potential secondary content and the overall primary content, and/or between each potential secondary content and each of the primary content segments. The Selection and Positioning Module (20) then selects one or more secondary contents that received the highest correlation level value(s) to the primary content, or one or more ‘secondary content’ to ‘primary content segment’ couples that received the highest correlation level value(s) to each other for presentation; retrieves the selected secondary content (s) from the Bank of Potential Secondary Contents (50); and relays the selected secondary content (s) and their positioning to a Secondary Content Embedding Module (30). The Secondary Content Embedding Module (30) then retrieves the primary content from a Primary Content Storage (80), embeds the selected secondary content(s) into it at the selected position(s), and presents/communicates the secondary-content-embedded content to viewer(s).

In FIG. 3B there is shown in further detail, in accordance with some embodiments of the present invention, a block diagram of an exemplary system for assessing the impact of previously presented secondary content(s) to a target/viewer. A Taste Profile Based Correlation Module (10) receives/reads: genome data of presented secondary content(s) from a Bank of Presented Secondary Contents (50), per-segment genome data for the segment(s) of the primary content in which the secondary content(s) were presented (e.g. in return to a query indicating the positioning of the presented secondary content(s)) from a Primary Content Segments Genome Data Storage (60), and viewer taste profile and/or preferences data from a Viewer Taste Profile and/or Preferences Data Storage (70). The Taste Profile Based Correlation Module (10) derives/calculates, based on their genome data, data indicative of the correlation level between the presented secondary content(s) and their respective primary content segments.

According to some embodiments, the Taste Profile Based Correlation Module (10) further derives/calculates, based on their genome data and taste profile based preferences, data indicative of the correlation level between some or all of the presented secondary content(s) and their viewer(s), and/or data indicative of the correlation level between some or all of the segments of the primary content and the secondary content(s) viewer(s). According to some embodiments, the Taste Profile Based Correlation Module (10) uses the taste profile based preferences of the projected viewer(s) for adjusting previously derived/calculated secondary content(s) to ‘primary-content/primary-content-segments’ correlation levels.

Derived/calculated correlation indicative data, represented as ‘Presented Secondary Content(s)’ to their respective ‘Primary Content Segments’ genomes delta values, are relayed to a Secondary Content Impact Assessment Module (20) that uses them to calculate a genomes based correlation level value between each presented secondary content and the primary content segment in which it was presented. The Impact Assessment Module (20) then relays the assessed impact of the presented secondary content(s) based on their correlation level value(s) to: the primary content, and/or to the primary content segment in which they were presented.

In FIGS. 4A and 4B there are shown, in accordance with some embodiments of the present invention, flowcharts of the main steps and decisions executed by a simplified exemplary system for assessing the relevance/impact of secondary contents to a target/viewer, as part of an exemplary secondary content(s) assessment process. In this example, based on comparisons of: primary content genome(s), secondary content(s) genome(s), and a viewer's taste profile; the relevance/impact of the examined secondary content(s) to the examined primary content (or segments thereof), when viewed by the viewer to which the examined taste profile belongs, is rated as either a LOW, a MEDIUM or a HIGH secondary content relevance/impact.

In FIG. 4A there is shown, in accordance with some embodiments of the present invention, a flowchart of the main steps and decisions executed by an exemplary system for assessing the relevance of secondary contents to a target/viewer, as part of an exemplary secondary contents assessment process. The method exemplified comprises the following steps and decisions: Receiving viewer(s) taste profile or preferences, genome data of a first primary content segment, and genome data of a first potential secondary content (1000); and calculating a set of one or more genome delta values, between the viewer and the secondary content, between the viewer and the primary content segment, and between the secondary content and the primary content segment (2000). The system then proceeds to examining a set of conditions relating to the calculated delta values:

If the primary content segment genome is approximately equal (e.g. substantially small delta values between them) to the viewer(s) preference profile (3000) than: if the secondary content genome is approximately equal to the primary content segment genome the correlation level of the secondary content is set to HIGH (3100), else, if the secondary content genome is approximately equal to the viewer(s) preference profile the correlation level of the secondary content is set to MEDIUM (3200), else, the correlation level is set to LOW (3300).

If, on the other hand, the primary content segment genome is not approximately equal (e.g. substantially large delta values between them) to the viewer(s) preference profile (3000) than: if the secondary content genome is approximately equal to the primary content segment genome the correlation level of the secondary content is set to LOW (3500), else, if the secondary content genome is approximately equal to the viewer(s) preference profile the correlation level of the secondary content is set to HIGH (3600), else, the correlation level is set to MEDIUM (3700).

The system than proceeds to: logging the correlation level result (4000), and checking whether additional secondary contents are awaiting assessment (5000). If additional potential secondary contents are awaiting assessment an additional secondary content is read (6000) and the process is repeated. Once all secondary contents have been assessed and their correlation level to the examined primary content segment has been calculated, the system proceeds to checking whether additional primary content segments are awaiting assessment (7000). If additional primary content segments are awaiting assessment, the next segment is read (8000) and the process is repeated with now the additional read primary content segment being compared to the viewer taste profile or preferences and each of the potential secondary contents. Finally, one or more ‘secondary content’ and ‘primary content segment’ couples, that received the highest correlation level score (e.g. HIGH) are outputted for embedding into the primary content and presentation.

In FIG. 4B there is shown, in accordance with some embodiments of the present invention, a flowchart of the main steps and decisions executed by an exemplary system for assessing the impact of previously presented secondary content(s) to a target/viewer, as part of an exemplary secondary contents assessment process. The method exemplified comprises the following steps and decisions: Receiving viewer(s) taste profile or preferences, genome data of the primary content segment where the presented secondary content was positioned, and genome data of the presented secondary content (1000); and calculating a set of one or more genome delta values, between the viewer and the secondary content, between the viewer and the primary content segment, and between the secondary content and the primary content segment (2000). The system then proceeds to examining a set of conditions relating to the calculated delta values:

If the primary content segment genome is approximately equal (e.g. substantially small delta values between them) to the viewer(s) preference profile (3000) than: if the secondary content genome is approximately equal to the primary content segment genome the correlation level of the secondary content is set to HIGH (3100), else, if the secondary content genome is approximately equal to the viewer(s) preference profile the correlation level of the secondary content is set to MEDIUM (3200), else, the correlation level is set to LOW (3300).

If, on the other hand, the primary content segment genome is not approximately equal (e.g. substantially large delta values between them) to the viewer(s) preference profile (3000) than: if the secondary content genome is approximately equal to the primary content segment genome the correlation level of the secondary content is set to LOW (3500), else, if the secondary content genome is approximately equal to the viewer(s) preference profile the correlation level of the secondary content is set to HIGH (3600), else, the correlation level is set to MEDIUM (3700).

The system than proceeds to: logging the correlation level result (4000); and outputting the result to a secondary contents analysis, valuation and/or pricing system and/or module.

According to some embodiments of the present invention, a system for impact assessment of secondary content may comprise: digital processing circuitry; and digital memory including digital processor executable code adapted to provide: at least one assessment module to assess a correlation between characteristics of a primary content segment and characteristics of a secondary content segment presented in conjunction.

According to some embodiments of the present invention, a system for impact assessment of secondary content may further comprise: an assessment module to assess a correlation between a characteristic of the secondary content segment and a taste profile of a viewer of the primary content segment.

According to some embodiments of the present invention, a system for impact assessment of secondary content may be designed to include one or more of the following features/configurations, such that: one of the assessment modules is an impact assessment module adapted to assess an impact of a secondary content viewed by the viewer; one of the assessment modules is a relevance assessment module adapted to assess a relevance of a secondary content being considered for presentation with the primary content segment; assessing correlation between a characteristic of primary content segments and secondary content segments includes calculating a semantic distance function; assessing correlation between a characteristic of the secondary content segment and a taste profile of a viewer of the primary content segment includes calculating a semantic distance function; assessing correlation between a characteristic of the secondary content segment and a taste profile of a viewer of the primary content segment includes calculating a distance between a characteristic of the secondary content and a dominant taste parameter of the viewer; and/or assessing correlation between a characteristic of the secondary content segment and a taste profile of a viewer of the primary content segment includes calculating a distance between a characteristic of the secondary content and a taste parameter of a taste profile of a cluster of users having similar tastes.

According to some embodiments of the present invention, a method for impact assessment of secondary content may comprise: assessing a correlation between characteristics of a primary content segment and characteristics of a secondary content segment presented in conjunction.

According to some embodiments of the present invention, a method for impact assessment of secondary content may further comprise: assessing a correlation between a characteristic of the secondary content segment and a taste profile of a viewer of the primary content segment.

According to some embodiments of the present invention, a method for impact assessment of secondary content may be designed to include one or more of the following features/steps, such that: assessment includes assessing an impact of a secondary content viewed by the viewer; assessment includes assessing a relevance of a secondary content being considered for presentation with the primary content segment; assessing correlation between a characteristic of primary content segments and secondary content segments includes calculating a semantic distance function; assessing correlation between a characteristic of the secondary content segment and a taste profile of a viewer of the primary content segment includes calculating a semantic distance function; assessing correlation between a characteristic of the secondary content segment and a taste profile of a viewer of the primary content segment includes calculating a distance between a characteristic of the secondary content and a dominant taste parameter of the viewer; and/or assessing correlation between a characteristic of the secondary content segment and a taste profile of a viewer of the primary content segment includes calculating a distance between a characteristic of the secondary content and a taste parameter of a taste profile of a cluster of users having similar tastes.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for impact assessment of secondary content comprising:
digital processing circuitry; and
digital memory including digital processor executable code adapted to provide:
at least one assessment module to assess a correlation between characteristics of a primary content segment and characteristics of a secondary content segment presented in conjunction.

2. The system according to claim 1, further comprising an assessment module to assess a correlation between a characteristic of the secondary content segment and a taste profile of a viewer of the primary content segment.

3. The system according to claim 2, wherein one of the assessment modules is an impact assessment module adapted to assess an impact of a secondary content viewed by the viewer.

4. The system according to claim 2, wherein one of the assessment modules is a relevance assessment module adapted to assess a relevance of a secondary content being considered for presentation with the primary content segment.

5. The system according to claim 1, wherein assessing correlation between a characteristic of primary content segments and secondary content segments includes calculating a semantic distance function.

6. The system according to claim 2, wherein assessing correlation between a characteristic of the secondary content segment and a taste profile of a viewer of the primary content segment includes calculating a semantic distance function.

7. The system according to claim 2, wherein assessing correlation between a characteristic of the secondary content segment and a taste profile of a viewer of the primary content segment includes calculating a distance between a characteristic of the secondary content and a dominant taste parameter of the viewer.

8. The system according to claim 2, wherein assessing correlation between a characteristic of the secondary content segment and a taste profile of a viewer of the primary content segment includes calculating a distance between a characteristic of the secondary content and a taste parameter of a taste profile of a cluster of users having similar tastes.

9. A method for impact assessment of secondary content comprising:
assessing a correlation between characteristics of a primary content segment and characteristics of a secondary content segment presented in conjunction.

10. The method according to claim 9, further comprising assessing a correlation between a characteristic of the secondary content segment and a taste profile of a viewer of the primary content segment.

11. The method according to claim 10, wherein assessment includes assessing an impact of a secondary content viewed by the viewer.

12. The method according to claim 10, wherein assessment includes assessing a relevance of a secondary content being considered for presentation with the primary content segment.

13. The method according to claim 9, wherein assessing correlation between a characteristic of primary content segments and secondary content segments includes calculating a semantic distance function.

14. The method according to claim 10, wherein assessing correlation between a characteristic of the secondary content segment and a taste profile of a viewer of the primary content segment includes calculating a semantic distance function.

15. The method according to claim 10, wherein assessing correlation between a characteristic of the secondary content segment and a taste profile of a viewer of the primary content segment includes calculating a distance between a characteristic of the secondary content and a dominant taste parameter of the viewer.

16. The method according to claim 10, wherein assessing correlation between a characteristic of the secondary content segment and a taste profile of a viewer of the primary content segment includes calculating a distance between a characteristic of the secondary content and a taste parameter of a taste profile of a cluster of users having similar tastes.
